(19) United States
(12) Patent Application Publication
(10) Pub. No.: US 2014/0193781 A1
(43) Pub. Date: Jul. 10, 2014

(54) FACILITATING FULFILLMENT AND VERIFICATION OF PRE-LICENSING REQUIREMENTS OF A MOTOR VEHICLE AGENCY FOR A STUDENT DRIVER

(71) Applicant: Alexander C. Sands, Herndon, VA (US)

(72) Inventor: Alexander C. Sands, Herndon, VA (US)

(21) Appl. No.: 13/734,289

(22) Filed: Jan. 4, 2013

(51) Int. Cl. G09B 19/16

(52) U.S. Cl. CPC G09B 19/167
USPC 434/64

(57) ABSTRACT

Fulfillment and verification of pre-licensing requirements of a motor vehicle agency may be facilitated for a student driver. In certain implementations, a duration of time associated with driving of the student driver may be recorded. The recording occurs during the time associated with the driving. The time duration associated with the driving may be stored in a student-driving session. The student-driving session may be stored. A presence of a first supervisor of the student driver with the student driver during the driving may be confirmed. In some implementations, the pre-licensing requirements may be obtained. The pre-licensing requirements and the stored student-driving session may be compared to generate status information of the student driver with respect to fulfillment of the pre-licensing requirements. In various implementations, the status information may be provided to the motor vehicle agency responsive to a determination that the student driver has fulfilled the pre-licensing requirements.

### FIELD OF THE DISCLOSURE

This disclosure relates to facilitating fulfillment and verification of one or more pre-licensing requirements of a motor vehicle agency for a student driver.

### BACKGROUND

To become licensed drivers, student drivers are generally required to satisfy various pre-licensing requirements mandated by their state's motor vehicle agency. For example, Virginia's motor vehicle agency (e.g., Virginia's Department of Motor Vehicles in conjunction with its Department of Education) requires that student drivers go through a “45-Hour Driving Log” process found in its “45-Hour Parent/Teen Driving Guide.” The “45-Hour Driving Log” process, for instance, include a number of pre-licensing requirements, such as completion of at least 40 driving sessions that are supervised by an appropriate individual, performance of at least 45 hours within the 40 driving sessions, recording and verification of log entries specifying the driving sessions and the associated hours, and/or other pre-licensing requirements. However, typical pre-licensing processes such as Virginia's “45-Hour Driving Log” process are associated with a number of issues, including difficulty with verification and/or other issues. As an example, a typical method of verification of a student driver's log in Virginia is his/her parent's or legal guardian's signature. While the Virginia driving log form makes it clear to the parent or legal guardian that making any false statements could lead to criminal prosecution, the log form provides no concrete evidence that the supplied information is indeed correct. As another example, the existing process results in an unnecessary amount of paperwork when student drivers submit their logs. In addition to the paperwork, a student driver typically must manually review each of the driving log entries to ensure he/she included all 45 hours and covered 40 driving sessions. As a further example, Virginia's process requires student drivers to have their logs with them whenever they record driving hours (e.g., since all log entries must be filled out on the same form). As such, if a student driver loses his/her log, all log entries of their previously completed driving hours will be lost. These and other drawbacks exist with Virginia's pre-licensing process and with other state pre-licensing processes.

### SUMMARY

One aspect of the disclosure relates to a system configured to facilitate fulfillment and verification of one or more pre-licensing requirements of a motor vehicle agency for a student driver, in accordance with one or more implementations. In some implementations, an amount of time that the student driver spends driving under the supervision of an appropriate individual (e.g., a parent, a legal guardian, and/or other appropriate individuals) may be recorded and verified. For example, verification that the student driver drove for the recorded time under the supervision of an appropriate individual may be performed via electronic confirmation. In one scenario, for instance, fulfillment and verification of the pre-licensing requirements may be facilitated through the use of one or more mobile applications. A mobile application may record a duration Of time associated with driving of the student driving. The mobile application may confirm that a supervisor of the student driver was present with the student driver during the driving. The time duration and the confirmation may be electronically stored.

In another scenario, a student-driver application may store a student-driving session. The stored student-driving session may include session information associated with the driving of the student driver, such as an identifier for identifying the student driver, the time duration associated with the driving, date/time of the driving, distance traveled during the driving, route traveled during the driving, and/or other session information. A supervisor application may store a supervisory session. The stored supervisory session may include session information associated with supervision of the driving, such as an identifier for identifying a supervisor of the student driver, a time duration associated with supervision of driving of a student driver, date/time of the supervision, distance traveled during the supervision, route traveled during the supervision, and/or other session information. The stored student-driving session and the stored supervisory session may be compared to determine whether the driving (e.g., indicated in the stored student-driving session) should be confirmed as having been supervised by an appropriate individual, for instance, via comparison to determine whether the stored student-driving session and the stored supervisory session match and/or via other comparison techniques.

In exemplary implementations, the system may be configured to streamline pre-licensing processes, for instance, by: (1) reducing paperwork involved with such pre-licensing processes; (2) automating submissions of session information corresponding to student-driving sessions (e.g., driving time records, driving mileage records, confirmation records of supervision of the student driver's driving, etc.); (3) automating the update of the student driver's accounts (e.g., with a licensing service, the motor vehicle agency, etc.); (4) providing verification associated with student-driving sessions (e.g., to ensure that the student driver has completed the required driving time, to confirm that the student driver had supervision while driving for all of the student-driving sessions, etc.); (5) automatically notifying the student driver, the supervisors of the student driver, the motor vehicle agency, etc., of the completion of the pre-licensing requirements by the student driver; (6) maintaining updated online accounts for each student driver so that the student drivers can keep track of their progress from any Internet-enabled device; (7) reducing manual processes and errors associated with such manual processes; (8) enabling the motor vehicle agency to access status information and/or other information with respect to the student drivers (e.g., by storing the status information, the session information, etc., on servers accessible to the motor vehicle agency); and/or (9) providing other approaches. As a result, the system may improve reliability of the pre-licensing process and prevent loss of driving session information, as well as decrease overhead costs, reduce administrative labor, mitigate the impact on the environment by reducing the amount of paperwork, and/or provide other advantages over typical pre-licensing processes.

In some implementations, the system may include a licensing platform. The licensing platform may be configured to execute one or more computer program modules. The computer program modules may include one or more of a recording module, a driving detection module, a safety module, a session storage module, a supervisor confirmation module, a compliance determination module, a notification module, and/or other modules.

The recording module may be configured to record a duration of time associated with the driving of a student driver. For example, the recording may occur during the time associated with the driving. The recording module may be configured to store the time duration associated with the driving in a student-driving session. As an example, the recording of the time duration associated with the driving may be initiated and stopped manually and/or automatically. In one scenario, a student driver may select a “start” button on a mobile application of the student driver's cell phone (e.g., a client computing platform) to start the recording of the time duration, and the student driver may select a “stop” button on the mobile application to stop the recording of the time duration. The total time from the time the “start” button is selected to the time the “stop” button is selected may then be stored as part of a student-driving session. In another scenario, the recording of the time duration associated with the driving may be initiated based on detecting that the student driver has begun driving (e.g., via GPS tracking, velocity/accelerator detection, etc.), and the recording of the time duration associated with the driving may be stopped based on detecting that the student driver has stopped driving (e.g., the student driver is outside the vehicle, the vehicle has not moved for a predetermined time threshold, etc.).

In some implementations, the driving detection module may be configured to detect the driving of the student driver. For example, the driving detection module may detect the driving in response to detecting one or more of velocity or acceleration from the driving. In certain implementations, the recording module may be configured to initiate the recording of the duration of time associated with the driving (among other values) in response to a determination by the driving detection module that the student driver is driving.

The session storage module may be configured to store the student-driving session. By way of example, the stored student-driving session may include session information associated with the driving of the student driver, such as an identifier for identifying the student driver, the time duration associated with the driving, date/time of the driving, distance traveled during the driving, route traveled during the driving, and/or other session information. The student-driving session may be stored locally on the cell phone, remotely at one or more network services, etc. The student-driving session may, for instance, be stored along with other student-driving sessions associated with the student driver so that the student-driving sessions may be analyzed to determine whether the student driver has fulfilled one or more pre-licensing requirements of a motor vehicle agency. In this way, because of the electronic storage of the student-driving sessions, the system may reduce the amount of paperwork associated with typical pre-licensing processes, provide electronic verification with respect to completion of pre-licensing requirements, and/or offer other benefits (e.g., increased portability of records, reduced probability of loss of driving session information, etc.).

The supervisor confirmation module may be configured to confirm a presence of a first supervisor of the student driver with the student driver during the driving. The first supervisor may, for instance, include a parent, a legal guardian, and/or any other authorized supervisor who is present with the student driver during the driving. In various implementations, the supervisor confirmation module may be configured to prompt the first supervisor to enter an input to indicate the presence of the first supervisor. The confirmation of the presence may be responsive to the input entered by the first supervisor. In some implementations, the supervisor confirmation module may be configured to prompt a second supervisor to enter an input to indicate the presence of the first supervisor. The confirmation of the presence may be responsive to the input entered by the second supervisor. The second supervisor may, for instance, include a parent, a legal guardian, and/or any other authorized supervisor who may not necessarily be present with the student driver during the driving, but can attest that the driving of the student driver was directly supervised by the first supervisor in the first supervisor's presence.

In certain implementations, the supervisor confirmation module may be configured to detect a proximity of the first supervisor to the student driver that is within a predetermined threshold during the driving. The confirmation of the presence may be responsive to the proximity detection. The predetermined threshold for the proximity may, for instance, be a few feet such that the first supervisor may be required to be at most a few feet away from the student driver during the driving in order for the student-driving session to be confirmed. In this way, the presence of the first supervisor may be automatically confirmed without necessarily requiring a manual confirmation by the first supervisor and/or any other authorized supervisor of the pre-licensing process.

In some implementations, the supervisor confirmation module may be configured to obtain a supervisory session associated with supervision of the student driver by the first supervisor. The supervisory session may include session information associated with supervision of the driving, such as an identifier for identifying the first supervisor, a time duration associated with supervision of driving of a student driver, date/time of the supervision, distance traveled during the supervision, route traveled during the supervision, and/or other session information. The supervisor confirmation module may be configured to compare the stored student-driving session and the supervisory session to determine whether the stored student-driving session and the supervisory session match. The confirmation of the presence may be responsive to a determination that the stored student-driving session and the supervisory session match. For example, if the obtained supervisory session and the stored student-driving session indicate substantially the same distance traveled, the same route traveled, the same time duration, the same time/date of the driving, and/or other information that match, it may be determined that the obtained supervisory session and the stored student-driving session match and that the first supervisor was present with the student-driver for the student-driving session.

In various implementations, the recording module may be configured to record a duration of time associated with supervision of the student driver by the first supervisor. The recording module may be configured to store the time duration associated with the supervision in the student-driving session. The session storage module may be configured to store the supervisory session. The stored supervisory session may include session information associated with supervision of the driving, such as an identifier for identifying the first supervisor, a time duration associated with supervision of driving of a student driver, date/time of the supervision, distance traveled during the supervision, route traveled during the supervision, and/or other session information. The supervisor confirmation module may be configured to compare the stored student-driving session and the stored supervisory session to determine whether the stored student-driving session and the stored supervisory session match. The confirmation of the presence may be responsive to a determination that the stored student-driving session and the stored supervisory session match.

In some implementations, the compliance determination module may be configured to obtain and/or store one or more pre-licensing requirements of, a motor vehicle agency. The compliance determination module may be configured to compare the pre-licensing requirements and the stored student-driving session to generate status information of the student driver with respect to fulfillment of the pre-licensing requirements. In one scenario, the status information may then be provided to the student driver, supervisors, and/or other authorized parties via the mobile application to keep the student driver informed of his/her status with respect to the pre-licensing requirements (e.g., the pre-licensing requirements that the student driver has fulfilled, the pre-licensing requirements that the student driver still needs to satisfy, etc.).

In certain implementations, the notification module may be configured to provide the status information to the motor vehicle agency, the student driver, and/or other entities (e.g., a parent of the student driver, a supervisor of the student driver, etc.). In one scenario, the status information may be provided to the motor vehicle agency responsive to a determination that the student driver has fulfilled the pre-licensing requirements. In some implementations, the compliance determination module may be configured to determine whether the student driver has fulfilled the pre-licensing requirements based on the comparison of the pre-licensing requirements and the stored student-driving session. By way of example, the compliance determination module may analyze the stored student-driving session along with other stored student-driving sessions associated with the student driver to determine whether those student-driving sessions indicate that the student driver has satisfied all of the pre-licensing requirements to enable the student driver to take a licensing test with the motor vehicle agency (e.g., vision test, driving test, etc.). Upon determining that the student driver has met all of the pre-licensing requirements, the compliance determination module may trigger the notification module to provide the status information (e.g., information indicating that the student driver has fulfilled all the pre-licensing requirements, session information generated from the various student-driving sessions of the student driver, etc.) to the motor vehicle agency.

In certain implementations, the compliance determination module and/or other modules of the licensing platform may be configured to work with the motor vehicle agency. For example, the licensing platform may work with the motor vehicle agency to pre-qualify the student driver to take a licensing test, to schedule the licensing test, etc. In one use case, upon determining that the student driver has fulfilled the pre-licensing requirements, the compliance determination module may determine one or more available time periods at various licensing facilities associated with the motor vehicle agency during which the student driver can take his/her licensing test. Those available time periods may be provided to the student driver so that the student driver may schedule his/her licensing test during one of the available time periods at one of the licensing facilities.

In various implementations, the compliance determination module may be configured to obtain session information corresponding to a student-driving session associated with a student driver. The session information may indicate a duration of time associated with driving of the student driver. The time duration associated with the driving may be recorded during the time associated with the driving. The supervisor confirmation module may be configured to confirm a presence of the first supervisor of the student driver with the student driver during the driving.

In some implementations, the compliance determination module may be configured to obtain and/or store one or more pre-licensing requirements of a motor vehicle agency. The compliance determination module may be configured to compare the pre-licensing requirements and the session information to generate status information of the student driver with respect to fulfillment of the pre-licensing requirements. In other implementations, the notification module may be configured to provide the status information to the motor vehicle agency, the student driver, and/or other entities (e.g., a parent of the student driver, a supervisor of the student driver, etc.). In one scenario, the status information may be provided to the motor vehicle agency responsive to a determination that the student driver has fulfilled the pre-licensing requirements.

In certain implementations, the safety module may be configured to disable external communications that are unrelated to the student-driving session responsive to a determination that the driving has begun. In various implementations, the safety module may be configured to enable the external communications responsive to a determination that the driving has ended. Such external communications may, for instance, include voice calls, text messaging, multimedia messaging, and/or other external communications that are unrelated to the student-driving session. In this way, the safety module may reduce accidents related to voice calls, text messaging, multimedia messaging, etc., while driving and, thus, improve the safety of the student drivers as well as the safety of the supervisors of the student drivers, other drivers, pedestrians, and/or anyone else that may share the road with the student drivers.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to facilitate fulfillment and verification of one or more pre-licensing requirements of a motor vehicle agency for a student driver, in accordance with one or more implementations.

FIG. 2 illustrates a diagram of the components of a licensing platform, in accordance with one or more implementations.

FIG. 3 illustrates a diagram of a mobile application configured to facilitate fulfillment and verification of one or more pre-licensing requirements of a motor vehicle agency for a student driver, in accordance with one or more implementations.

FIG. 4 illustrates a diagram of a notification email to a supervisor of a student driver upon completion of a student-driving session, in accordance with one or more implementations.

FIG. 5 illustrates a method for facilitating fulfillment of one or more pre-licensing requirements of a motor vehicle agency for a student driver, in accordance with one or more implementations.

FIG. 6 illustrates a method for confirming supervision presence with the student driver for the student-driving session, in accordance with one or more implementations.

FIG. 7 illustrates another method for facilitating fulfillment and verification of one or more pre-licensing requirements of a motor vehicle agency for a student driver, in accordance with one or more implementations.

FIG. 8 illustrates another method for facilitating fulfillment and verification of one or more pre-licensing requirements of a motor vehicle agency for a student driver, in accordance with one or more implementations.

### DETAILED DESCRIPTION

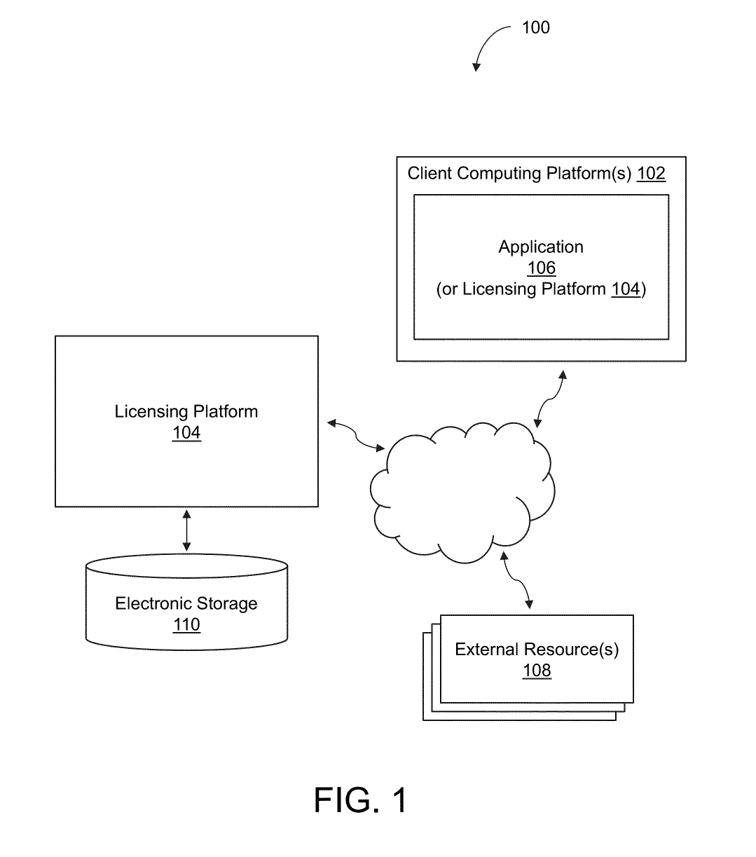

FIG. 1 illustrates a system 100 configured to facilitate fulfillment and verification of one or more pre-licensing requirements of a motor vehicle agency for a student driver, in accordance with one or more implementations. In some implementations, the system may include a client computing platform 102 (or multiple client computing platforms 102) having connectivity to a licensing platform 104 via one or more communication links. The client computing platform 102 may include or have access to an application 106 that enables the client computing platform 102 to interact with, for instance, the licensing platform 104, which may perform one or more functions as described herein. It is noted that the licensing platform 104 may be a separate entity of the system 100, a part of one or more servers (e.g., of network services of the system), included within the client computing platform 102, and/or provided in one or more other components of the system 100. As such, the servers, the client computing platform 102, and/or other components of the system 100 may perform the functions as described herein for the licensing platform 104.

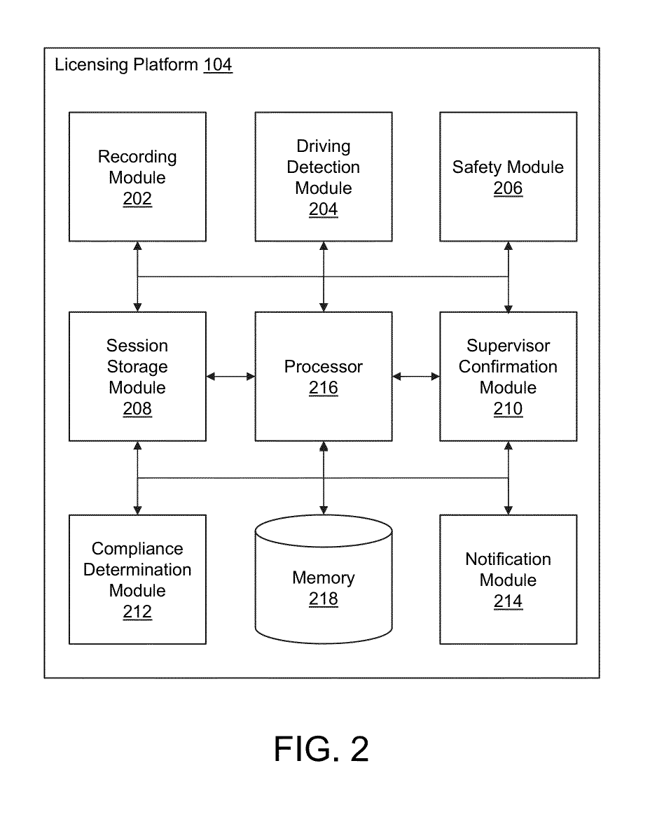

The licensing platform 104 may be configured to execute one or more computer program modules. By way of example, FIG. 2 illustrates a diagram of the components of the licensing platform 104, in accordance with one or more implementations. As shown in FIG. 2, components of the licensing platform 104 may include computer program modules. The computer program modules may include one or more of a recording module 202, a driving detection module 204, a safety module 206, a session storage module 208, a supervisor confirmation module 210, a compliance determination module 212, a notification module 214, and/or other modules.

The recording module 202 may be configured to record a duration of time associated with driving of a student driver. The recording may occur during the time associated with the driving. The recording module 202 may be configured to store the time duration associated with the driving in a student-driving session. As an example, the recording of the time duration associated with the driving may be initiated and stopped manually and/or automatically. In one scenario, a student driver may select a “start” button on a mobile application of the student driver's cell phone (e.g., a client computing platform) to start the recording of the time duration, and the student driver may select a “stop” button on the mobile application to stop the recording of the time duration. The total time from the time the “start” button is selected to the time the “stop” button is selected may then be stored as part of a student-driving session. In another scenario, the recording of the time duration associated with the driving may be initiated based on detecting that the student driver has begun driving (e.g., via GPS tracking, velocity/accelerator detection, etc.), and the recording of the time duration associated with the driving may be stopped based on detecting that the student driver has stopped driving (e.g., the student driver is outside the vehicle, the vehicle has not moved for a predetermined time threshold, etc.).

In some implementations, the driving detection module 204 may be configured to detect the driving of the student driver. For example, the driving detection module 204 may detect the driving in response to detecting one or more of velocity or acceleration from the driving. In certain implementations, the recording module 202 may be configured to initiate the recording of the duration of time associated with the driving (among other values) in response to a determination by the driving detection module 204 that the student driver is driving. In one scenario, the driving detection module 204 may determine that the student driver is driving when the student driver has activated the “start” button on a mobile application of the student driver's cell phone and motion of the student driver's vehicle is detected (e.g., detected velocity has satisfied a predetermined threshold for indicating the beginning of a student-driving session). In another scenario, the driving detection module 204 may automatically determine that the student driver is driving based on detected velocities, detected accelerations, etc. As such, in some scenarios, the recording module 202 may automatically start recording of time and/or other values (e.g., date/time of driving, distance traveled, route traveled, whether the driving was during the day or at night, etc.) based on the detected velocities, detected accelerations, etc., without requiring the user to manually activate each student-driving session (e.g., application 106 of the client computing platform 102 may be set to automatically determine when to start recording).

In various implementations, the recording module 202 may be configured to work with the driving detection module 204 to determine when to stop the recording of the time duration associated with the driving. By way of example, the driving detection module 204 may trigger the recording module 202 to stop the recording of the time duration associated with the driving when the driving detection module 204 has detected that the vehicle is no longer in motion (e.g., detected velocity is below the predetermined threshold for indicating the beginning of a student-driving session) and that the student driver is outside of the vehicle.

The session storage module 208 may be configured to store the student-driving session. By way of example, the stored student-driving session may include session information associated with the driving of the student driver, such as an identifier for identifying the student driver, the time duration associated with the driving, date/time of the driving, distance traveled during the driving, route traveled during the driving, and/or other session information. The student-driving session may be stored locally on the cell phone, remotely at one or more network services, etc. The student-driving session may, for instance, be stored along with other student-driving sessions associated with the student driver so that the student-driving sessions may be analyzed to determine whether the student driver has fulfilled one or more pre-licensing requirements of a motor vehicle agency. As discussed, because of the electronic storage of the student-driving sessions, the system may reduce the amount of paperwork associated with typical pre-licensing processes, provide electronic verification with respect to completion of pre-licensing requirements, and/or offer other benefits (e.g., increased portability of records, reduced probability of loss of driving session information, etc.).

The supervisor confirmation module 210 may be configured to confirm a presence of a first supervisor of the student driver with the student driver during the driving. For example, the first supervisor may include a parent of the student driver, a legal guardian of the student driver, a person authorized by the motor vehicle agency to supervise the driving of the student driver, etc. In one use case, confirmation of the first supervisor's presence in the student driver's vehicle while the student driver was driving the vehicle may be stored in the student-driving session along with the time duration associated with the driving. In another scenario, the confirmation of the first supervisor's presence may be required before the stored student-driving session is counted towards completion of pre-licensing requirements of a motor vehicle agency.

In various implementations, the supervisor confirmation module 210 may be configured to prompt the first supervisor to enter an input to indicate the presence of the first supervisor. The confirmation of the presence may be responsive to the input entered by the first supervisor. In one scenario, a mobile application on the student driver's mobile device may be utilized to record the time duration associated with the driving. Prior to initiating the recording of the time duration, the supervisor (e.g., the first supervisor) who will be with the student driver in the vehicle during the driving may be required to enter his/her supervisor identifier and/or passcode into the mobile application to indicate that he/she will be supervising the student driver for the student-driving session.

In some implementations, the supervisor confirmation module 210 may be configured to prompt a second supervisor to enter an input to indicate the presence of the first supervisor. The confirmation of the presence may be responsive to the input entered by the second supervisor. The second supervisor may include a parent of the student driver, a legal guardian of the student driver, and/or any other authorized supervisor who may not necessarily be present with the student driver for the particular student-driving session, but is authorized by the motor vehicle agency to attest that the driving of the student driver was directly supervised by the first supervisor in the first supervisor's presence for the particular student-driving session. For example, a parent of the student driver may receive a voice call, a text message, an email, and/or other communications requesting that the parent confirm (e.g., subject to penalty of criminal prosecution) that the student driver was in the presence of the first supervisor for a particular student-driving session.

In certain implementations, the supervisor confirmation module 210 may be configured to detect a proximity of the first supervisor to the student driver that is within a predetermined threshold during the driving. The confirmation of the presence may be responsive to the proximity detection. The predetermined threshold for the proximity may, for instance, be a few feet such that the first supervisor may be required to be at most a few feet away from the student driver during the driving in order for the student-driving session to be confirmed. By way of example, both the student driver and the first supervisor may each have a mobile device with a mobile application configured with the licensing platform 104. The student driver's mobile application may be configured with the student driver's identification and the first supervisor's mobile application may be configured with the first supervisor's identification. As such, the student driver's mobile application may detect (e.g., via the student driver's mobile device based on near field communication (NFC) or other wireless technologies) that the first supervisor is in the vehicle with the student driver for the entirety of the time duration associated with the driving based on detecting that the first supervisor's mobile device is a few feet away from the student driver's mobile device (e.g., based on detecting the first supervisor's identification configured on the first supervisor's mobile application). In this way, the presence of the first supervisor may be automatically confirmed without necessarily requiring a manual confirmation by the first supervisor and/or any other authorized supervisor of the pre-licensing process.

In some implementations, the supervisor confirmation module 210 may be configured to obtain a supervisory session associated with supervision of the student driver by the first supervisor. The supervisory session may include session information associated with supervision of the driving, such as an identifier for identifying the first supervisor, a time duration associated with supervision of driving of a student driver, date/time of the supervision, distance traveled during the supervision, route traveled during the supervision, and/or other session information. The supervisor confirmation module 210 may be configured to compare the stored student-driving session and the supervisory session to determine whether the stored student-driving session and the supervisory session match. The confirmation of the presence may be responsive to a determination that the stored student-driving session and the supervisory session match. For example, if the obtained supervisory session and the stored student-driving session indicate substantially the same distance traveled, the same route traveled, the same time duration, the same time/date of the driving, and/or other information that match, it may be determined that the obtained supervisory session and the stored student-driving session match and that the first supervisor was present with the student-driver for the student-driving session. In one scenario, the student-driving session may be initiated and stored via a mobile application on the student driver's mobile device, while the supervisory session may be initiated and stored via a mobile application on the first supervisor's mobile device. The stored student-driving session from the student driver's mobile device and the stored supervisory session from the first supervisor's mobile device may be compared against each other to determine whether the first supervisor was present with the student driver in the vehicle during the driving.

In various implementations, the recording module 202 may be configured to record a duration of time associated with supervision of the student driver by the first supervisor. The recording module 202 may be configured to store the time duration associated with the supervision in the student-driving session. The session storage module 208 may be configured to store the supervisory session. The stored supervisory session may include session information associated with supervision of the driving, such as an identifier for identifying the first supervisor, a time duration associated with supervision of driving of a student driver, date/time of the supervision, distance traveled during the supervision, route traveled during the supervision, and/or other session information. The supervisor confirmation module 210 may be configured to compare the stored student-driving session and the stored supervisory session to determine whether the stored student-driving session and the stored supervisory session match. The confirmation of the presence may be responsive to a determination that the stored student-driving session and the stored supervisory session match.

By way of example, a mobile application on the student driver's mobile device may be configured to record and store the time duration associated with the driving in the student-driving session, along with being configured to record and store the time duration associated with the supervision of the student driver in the supervisory session. In one scenario, for instance, the first supervisor who will be present in the vehicle with the student driver during the driving may be required to enter the first supervisor's identifier and/or passcode into the mobile application to start the recording of the time duration associated with the supervision for the supervisory session. When the driving has ended, the first supervisor may be required to reenter the first supervisor's identifier and/or passcode into the mobile application to stop the recording of the time duration associated with the supervision for the supervisory session. Upon the stopping of the recording associated with the supervisory session, the time duration associated with the supervision may be stored in the supervisory session, which may then be stored on the mobile device.

On the other hand, the starting and stopping of the recording for the time duration associated with the driving for the student-driving session may be automatically performed (e.g., based on automated detection for the beginning and end of the driving). Upon the automatic stopping of the recording associated with the student-driving session, the time duration associated with the driving may be stored in the student-driving session, which may then be stored on the mobile device. The two stored sessions may be compared to determine whether the information in the stored sessions match to determine whether the first supervisor was present in the vehicle with the student driver during the driving. For example, if the stored student-driving session indicates that the student driver drove from time period X2-X9, and the stored supervisory session indicates that the first supervisor supervised the student driver from time period X1-X6, it may be determined that the stored sessions match with respect to the time period from X2-X6. As such, the presence of the first supervisor during the student driver's driving may be confirmed with respect to the time period from X2-X6.

In some implementations, the compliance determination module 212 may be configured to obtain and/or store one or more pre-licensing requirements of a motor vehicle agency. The compliance determination module 212 may be configured to compare the pre-licensing requirements and the stored student-driving session to generate status information of the student driver with respect to fulfillment of the pre-licensing requirements. The pre-licensing requirements may, for instance, require that the student driver drive a certain total number of hours, that the certain total number of hours be driven within a particular number of student-driving sessions, that the student-driving sessions include a certain number of day driving and a certain number of night driving, that all of the recorded time for the student-driving sessions be supervised and confirmed by an authorized supervisor, and/or that the student driver perform other necessary tasks. The pre-licensing requirements may be compared with the stored student-driving session and other stored student-driving sessions associated with the student driver to generate status information regarding the pre-licensing requirements that the student driver has fulfilled and the pre-licensing requirements that the student driver still needs to satisfy. The status information may be provided to the student driver via the mobile application to keep the student driver informed of his/her status with respect to the pre-licensing requirements.

In certain implementations, the notification module 214 may be configured to provide the status information to the motor vehicle agency, the student driver, and/or other entities (e.g., a parent of the student driver, a supervisor of the student driver, etc.). In one scenario, the status information may be provided to the motor vehicle agency responsive to a determination that the student driver has fulfilled the pre-licensing requirements. In some implementations, the compliance determination module 212 may be configured to determine whether the student driver has fulfilled the pre-licensing requirements based on the comparison of the pre-licensing requirements and the stored student-driving session. By way of example, the compliance determination module 212 may analyze the stored student-driving session along with other stored student-driving sessions associated with the student driver to determine whether those student-driving sessions indicate that the student driver has satisfied all of the pre-licensing requirements to enable the student driver to take a licensing test with the motor vehicle agency (e.g., vision test, driving test, etc.). Upon determining that the student driver has met all of the pre-licensing requirements, the compliance determination module 212 may trigger the notification module 214 to provide the status information (e.g., information indicating that the student driver has fulfilled all the pre-licensing requirements, session information generated from the various student-driving sessions of the student driver, etc.) to the motor vehicle agency.

In certain implementations, the compliance determination module 212 and/or other modules of the licensing platform 104 may be configured to work with the motor vehicle agency. For example, the licensing platform 104 may work with the motor vehicle agency to pre-qualify the student driver to take a licensing test, to schedule the licensing test, etc. In one use case, upon determining that the student driver has fulfilled the pre-licensing requirements, the compliance determination module 212 may determine one or more available time periods at various licensing facilities associated with the motor vehicle agency during which the student driver can take his/her licensing test. Those available time periods may be provided to the student driver via a mobile application of the client computing platform (e.g., mobile phone, built-in computer of the student driver's vehicle, etc.), text messaging, email, and/or other communication services. Upon receipt, the student driver may schedule his/her licensing test during one of the available time periods at one of the licensing facilities via one or more modules of the licensing platform 104 (e.g., a scheduling module (not shown)).

In various implementations, the compliance determination module 212 may be configured to obtain session information corresponding to a student-driving session associated with a student driver. The session information may indicate a duration of time associated with driving of the student driver. The time duration associated with the driving may be recorded during the time associated with the driving. The supervisor confirmation module 210 may be configured to confirm a presence of the first supervisor of the student driver with the student driver during the driving. By way of example, session information may be obtained by a network service (e.g., hosting the licensing platform 104) from the student driver's mobile device. The network service may determine whether the first supervisor was present with the student driver for the student-driving session using one or more of the confirmation techniques described herein. If, for instance, the network service determines that the first supervisor was present with the student driver, the network service may store the confirmation in the session information. As such, the confirmation and/or the other information of the session information along with other session information associated with the student driver may be utilized to determine whether the student driver has fulfilled certain pre-licensing requirements.

In some implementations, the compliance determination module 212 may be configured to obtain and/or store one or more pre-licensing requirements of a motor vehicle agency. The compliance determination module 212 may be configured to compare the pre-licensing requirements and the session information to generate status information of the student driver with respect to fulfillment of the pre-licensing requirements. In other implementations, the notification module 214 may be configured to provide the status information to the motor vehicle agency, the student driver, and/or other entities (e.g., a parent of the student driver, a supervisor of the student driver, etc.). In one scenario, the status information may be provided to the motor vehicle agency responsive to a determination that the student driver has fulfilled the pre-licensing requirements. As indicated, the pre-licensing requirements may be compared with the session information and other session information associated with the student driver to generate status information regarding the pre-licensing requirements that the student driver has fulfilled and the pre-licensing requirements that the student driver still needs to satisfy. Upon completion of all of the pre-licensing requirements, for instance, the status information may be provided to the motor vehicle agency to initiate scheduling of the licensing test that will enable the student driver to obtain a driver's license upon passing.

In certain implementations, the safety module 206 may be configured to disable external communications that are unrelated to the student-driving session responsive to a determination that the driving has begun. In various implementations, the safety module 206 may be configured to enable the external communications responsive to a determination that the driving has ended. Such external communications may, for instance, include voice calls, text messaging, multimedia messaging, and/or other external communications that are unrelated to the student-driving session. As indicated, because these types of external communications may be disabled while the student driver is driving, accidents related to voice calls, text messaging, multimedia messaging, etc., while driving may be reduced and, thus, the safety of the student drivers as well as the safety of the supervisors of the student drivers, other drivers, pedestrians, and/or anyone else that may share the road with the student drivers may be improved.

However, external communications that are related to the student-driving session may remain enabled while the student driver is driving. For example, if the safety module 206 is implemented in the student driver's mobile phone (e.g., client computing platform 102), the mobile phone may still be able to receive global positioning system (GPS) data to track the location of the student driver, to calculate the distance and route traveled by the student driver, and/or to perform other related operations. As another example, the mobile phone may still be able to receive emergency alerts related to weather conditions, traffic conditions, or other emergency events since such emergency alerts may be related to the safety of the student driver while driving. As yet another example, the mobile phone may still be able to initiate phone calls and/or other communication sessions to/with emergency services (e.g., 911, accident reporting services, etc.).

Still referring to FIG. 2, the licensing platform 104 may include processor 216, along with memory 218, that are configured to provide information processing capabilities for facilitating the processes of the computer program modules. As such, processor 216 may include one or more of a digital processor, an analog processor, a digital circuit designed to process information, an analog circuit designed to process information, a state machine, and/or other mechanisms for electronically processing information. Although processor 216 is shown in FIG. 2 as a single entity, this is for illustrative purposes only. In some implementations, processor 216 may include a plurality of processing units. These processing units may be physically located within the same device, or processor 216 may represent processing functionality of a plurality of devices operating in coordination. The processor 216 may be configured to execute modules 202, 204, 206, 208, 210, 212, 214, and/or other modules. The processor 216 may be configured to execute modules 202, 204, 206, 208, 210, 212, 214, and/or other modules by software; hardware; firmware; some combination of software, hardware, and/or firmware; and/or other mechanisms for configuring processing capabilities on processor 216. The description of the functionality provided by the different modules 202, 204, 206, 208, 210, 212, and/or 214 described below is for illustrative purposes, and is not intended to be limiting, as any of modules 202, 204, 206, 208, 210, 212, and/or 214 may provide more or less functionality than is described. For example, one or more of modules 202, 204, 206, 208, 210, 212, and/or 214 may be eliminated, and some or all of its functionality may be provided by other ones of modules 202, 204, 206, 208, 210, 212, and/or 214. As another example, processor 216 may be configured to execute one or more additional modules that may perform some or all of the functionality attributed below to one of modules 202, 204, 206, 208, 210, 212, and/or 214.

As noted, the licensing platform 104 may be included within the client computing platform 102, as part of one or more servers of the system 100, and/or provided by one or more other components of the system 100. By way of example, the client computing platform 102 may include one or more of a desktop computer, a laptop computer, a handheld computer, a netbook, a smartphone, a built-in computing device of an automobile, and/or other computing platforms. The servers may include communication lines, or ports to enable the exchange of information with a network and/or other computing platforms. The servers may include a plurality of hardware, software, and/or firmware components operating together to provide the functionality attributed herein to the licensing platform 104. For example, the servers may be implemented by a cloud of computing platforms operating together.

In some implementations, client computing platform 102, licensing platform 104, external resources 108, and/or other components of the system 100 (e.g., one or more servers of network services) may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which client computing platform 102, licensing platform 104, external resources 108, and/or other components of the system 100 may be operatively linked via some other communication media.

The external resources 108 may include sources of information (e.g., pre-licensing requirements of motor vehicle agencies, scheduling information with respect to licensing test time/dates, etc.), external entities participating with system 100, and/or other resources. In some implementations, some or all of the functionality attributed herein to external resources 108 may be provided by resources included in system 100.

The licensing platform 104 may have access to and/or include electronic storage 110, and/or other components. The electronic storage 110 may comprise electronic storage media that electronically stores information. The electronic storage media of electronic storage 110 may include one or both of system storage that is provided integrally (i.e., substantially non-removable) with one or more servers, the client computing platform 102, and/or removable storage that is removably connectable to the servers and/or the client computing platform 102, for example, a port (e.g., a USB port, a firewire port, etc.) or a drive (e.g., a disk drive, etc.). The electronic storage 110 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 110 may include one or more virtual storage resources (e.g., cloud storage, a virtual private network, and/or other virtual storage resources). The electronic storage 110 may store software algorithms, information received from the servers, information received from client computing platform 102, information received from external resources 108, and/or other information.

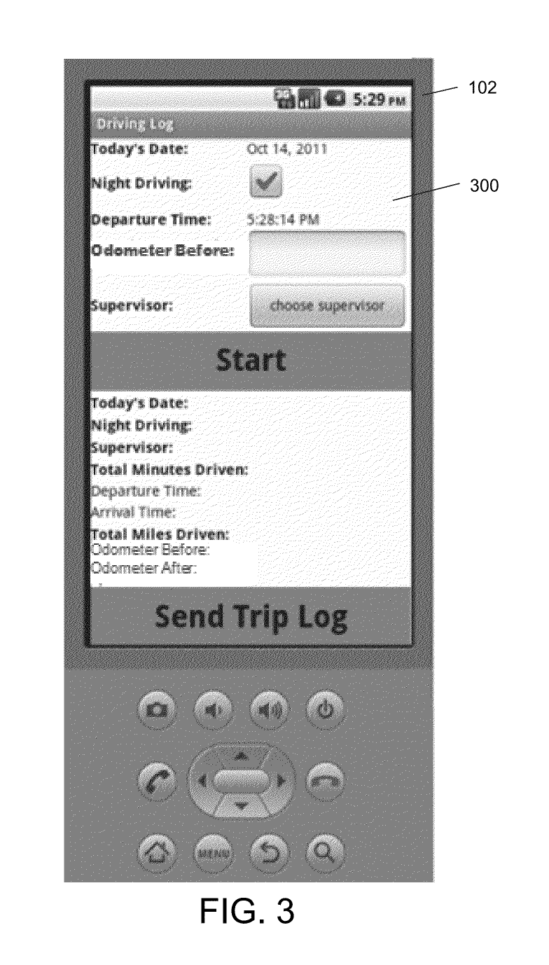

FIG. 3 illustrates a diagram of a mobile application 300 configured to facilitate fulfillment and verification of one or more pre-licensing requirements of a motor vehicle agency for a student driver, in accordance with one or more implementations. As shown, mobile application 300 may be a user friendly cell phone application (e.g., implemented on client computing platform 102) that combines all elements of a pre-licensing process of a motor vehicle agency into a simple, easy to use, mobile platform. Mobile application 300 may require certain user inputs, such as selecting the supervisor and inputting the mileage reading of the odometer before the student driver begins driving. The user inputs may be provided in a number of ways, including via a touch keypad, a convenient drop-down menu, etc., to simplify the user experience. Other inputs, such as “Date,” “Total Minutes Driven”, “Total Mileage”, “Night Driving,” etc., may be handled by mobile application 300.

As depicted in FIG. 3, mobile application 300 may display a large, clear “START” button. In some implementations, the “START” button may be activated when required user input (e.g., selection of the supervisor) has been provided. Activation of the “START” button may initiate recording of the date (e.g., using an internal clock), departure time (e.g., using an internal clock), departure location (e.g., using the GPS capability of client computing platform 102), and/or other information. These variables may later be utilized to calculate total minutes driven, total mileage, the type of driving session (e.g., night driving, day driving, etc.), and/or other information. In certain implementations, activation of the “START” button may automatically disable text messaging and/or other external communications that may not be related to a student-driving session, Such external communications may remain disabled until a “STOP” button is activated (e.g., the “STOP button may be presented after the “START” button is activated). As such, the disabling of such external communications may decrease cell phone usage while driving and, thus, increase the safety of student drivers, supervisors of the student drivers, other drivers, and/or anyone else that may share the road with the student drivers.

Upon completion of a driving session, the mobile application 300 may prompt the user (e.g., the student driver, the supervisor with the student driver, etc.) to decide whether to submit the session information (e.g., stored student-driving session) should to the motor vehicle agency. If, for instance, the user opts to submit the session information, the mobile application 300 may transmit the session information to a network service associated with the motor vehicle agency for storage at the motor vehicle agency's database. On the other hand, if the user declines to submit the session information, the mobile application 300 may send an email to the user to inform the user that the session information was not reported.

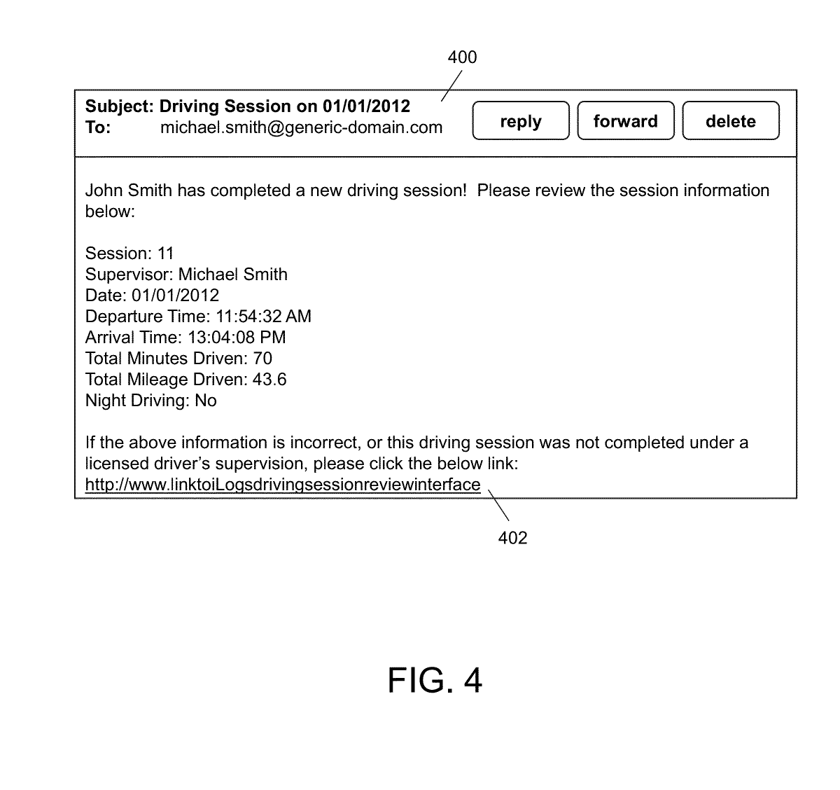

In various implementations, the mobile application 300 may notify the parent, legal guardian, and/or other authorized supervisor of the student driver of the driving session upon completing the driving session. The notification may, for instance, be provided via email, text messaging, and/or other communication techniques. For example, FIG. 4 illustrates a diagram of a notification email to a supervisor of a student driver upon completion of a student-driving session, in accordance with one or more implementations. As shown, the notification is sent as an email 400 to a supervisor, “Michael Smith,” informing him that “John Smith” has completed a new driving session. Email 400 asks the supervisor to review the details of the session information. If, for instance, any of the information is incorrect, or the driving session was not completed under a licensed driver's supervision, the supervisor is asked in email 400 to initiate a link 402 (e.g., to invalidate the driving session, to provide more information, etc.).

According to some implementations, additional verifications may be provided to increase reliability and safety associated with the pre-licensing process. For example, an additional text message feature may be added to a mobile application for the pre-licensing process. The feature may, for instance, send a text message with a pin number to the parent and/or other authorized supervisor of the student driver. The pin number may be required to begin the mobile application on the student driver's mobile device.

According to certain implementations, the student driver may be required to take picture of himself/herself and an authorized supervisor to increase reliability and safety. For example, a mobile application for the pre-licensing process may utilized face recognition techniques (e.g., of a mobile device) to determine if two people are visible in the picture. If, for instance, two people are not detected in the captured picture, the mobile application may not start the recording of the time duration for the student-driving session, and a parent of the student driver may be notified of the attempt to drive (e.g., without an authorized supervisor).

According to various implementations, a parent version of the mobile application for the pre-licensing process may be provided in addition to a student driver version. In such an implementation, a parent version may be released to provide two accounts of the driving session. The two accounts may, for instance, help confirm that a parent of the student driver is present in the vehicle and supervising the student driver as the student driver drives.

According to some implementations, the mobile application for the pre-licensing process may be extended to fit the needs of a variety of markets where there is a need for verifying various recorded information, such as hours worked, distanced traveled, and/or other recorded information. This may include, but is not limited to, any application where there is an incentive (monetary, time, etc.) for a user to falsify records, such as construction, environmental services, security/perimeter management, government vehicle operation, paid transport time, and/or other records. By way of example, with respect to construction, a mobile application may provide the ability to monitor and record the transport of construction materials (via cement trucks, dump trucks, etc.), construction workers, each worker's total time spent on construction site, driver safety for construction workers operating large vehicles, etc. By using the mobile application, a contractor may be alerted when construction materials are nearby. For example, a cell phone notification may alert the contractor that the cement truck is on-route, allowing him to prepare for cement filling by the time the truck arrives. In one scenario, the mobile application may eliminate the need for time sheets, as the construction workers recorded time may automatically be recorded whenever the workers enter/exit the construction site. In another scenario, the application may be used to monitor the safety of construction truck operators by tracking their average speeds on the highway, route selection, etc., increasing vehicle safety and ensuring that hired workers comply with road laws.

By way of another example, certain environmental services may have no evidence of service being provided other than an employee log. Such services may, for instance, include snow removal, outdoor home inspection, outdoor pest control, and/or other services. In such cases, a mobile application having features of the mobile application for the pre-licensing process may be applied to keep a record of provided service and use the record as evidence for billing. While there is clear evidence of, for example, whether or not a garbage collection service completed the entire route, it may still be useful to record the time and distance traveled using the mobile application for recordkeeping purposes. In this way, the mobile application may be used by management to eliminate the need for time sheets and potentially falsified employee work hours.

By way of another example, with respect to security/perimeter management, security guards may often be required to check-in at various locations along their route to ensure that they are constantly traveling the entire perimeter. A mobile application having features similar to the mobile application for the pre-licensing process may be applied to eliminate the need for any sort of en-route time stamp, as the mobile application may automatically record the location of the guards at all times.

By way of another example, regarding government vehicle operation, a mobile application having features similar to the mobile application for the pre-licensing process may be utilized to track GPS information on government vehicles to automatically calculate and record travel distance and time.

By way of another example, company employees are often paid for transportation time and costs. However, the reliability for the accuracy of travel time is left up to the integrity of the employee. As such, a mobile application having features similar to the mobile application for the pre-licensing process may be used to record the driving hours of the employees to each location. Thus, the mobile application may eliminate the need for employee-kept records. In some scenarios, the mobile application may monitor the travel distance and automatically estimate the travel costs for cross-reference with the charges for paid travel on an employee's expense report.

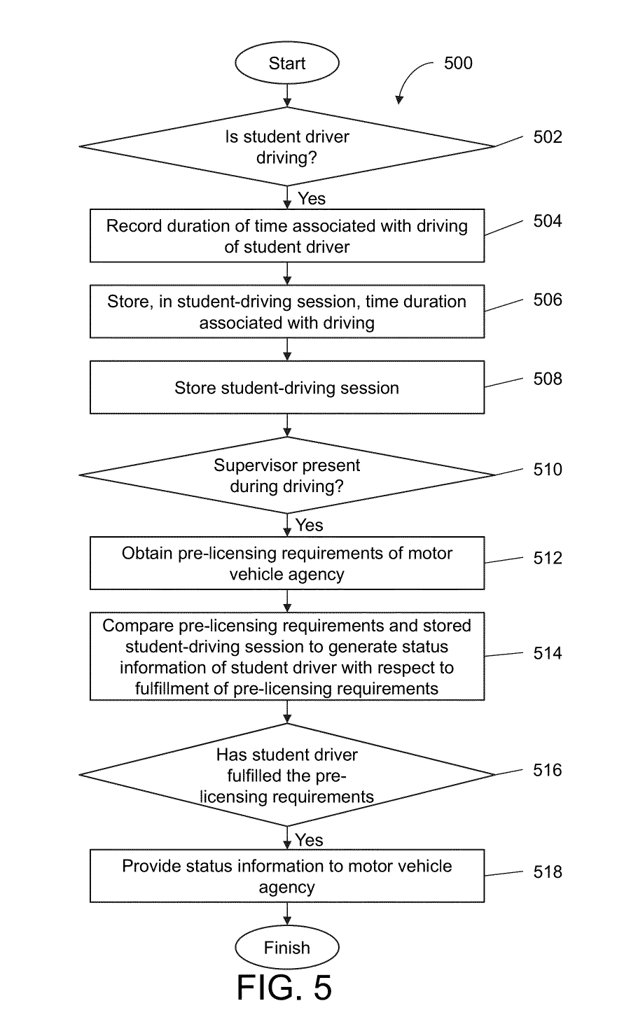

FIG. 5 illustrates a method for facilitating fulfillment and verification of one or more pre-licensing requirements of a motor vehicle agency for a student driver, in accordance with one or more implementations. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At an operation 502, a determination of whether the student driver is driving may be effectuated. As indicated, in some implementations, such a determination may be based on whether a user (e.g., the student driver, the first supervisor who is present with the student driver, etc.) of an associated mobile application manually indicates via the mobile application that the student driver is driving. In certain implementations, such a determination may be based on velocity information, acceleration information, GPS information, and/or other information indicating that the student driver is driving. Operation 502 may be performed by a driving detection module that is the same as or similar to driving detection module 204, in accordance with one or more implementations. Responsive to a determination that the student driver is driving, method 500 may proceed to an operation 504.

(70). At operation 504, a duration of time associated with the driving of the student driver may be recorded. The recording may occur during the time associated with the driving. In some implementations, the recording may be stopped when a user (e.g., the student driver, the first supervisor who is present with the student driver, etc.) of an associated mobile application manually indicates that the student driver is no longer driving. In various implementations, the recording may be stopped based on velocity information, acceleration information, GPS information, and/or other information indicating that the student driver is no longer driving. Operation 504 may be performed by a recording module that is the same as or similar to recording module 202, in accordance with one or more implementations.

At an operation 506, the time duration associated with the driving may be stored in a student-driving session. As discussed, in some implementations, the time duration associated with the driving may be stored in the student-driving session along with information, such as date/time of driving, distance traveled, route traveled, the type of driving, etc. Operation 506 may be performed by a recording module that is the same as or similar to recording module 202, in accordance with one or more implementations.

At an operation 508, the student-driving session may be stored. As discussed, the student-driving session may be stored on client computing platform 102, at one or more servers of a network service, etc. Operation 508 may be performed by a session storage module that is the same as or similar to session storage module 208, in accordance with one or more implementations.

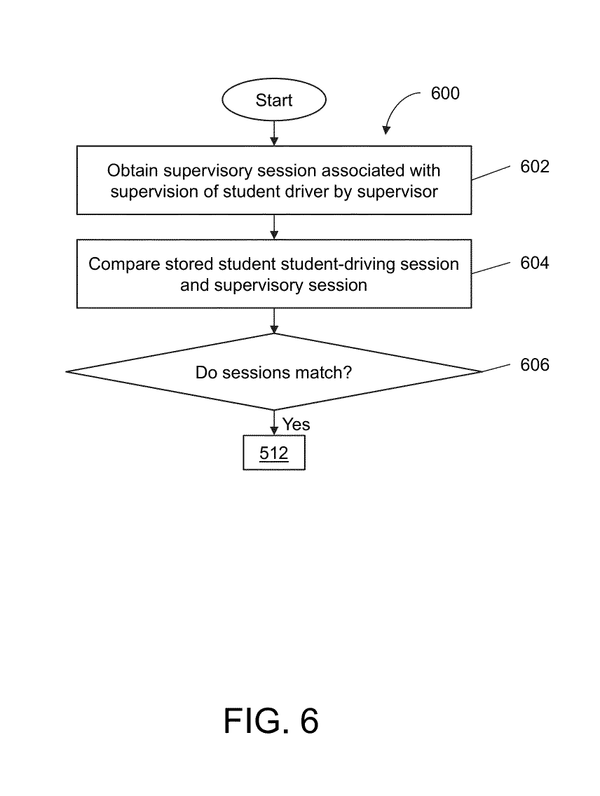

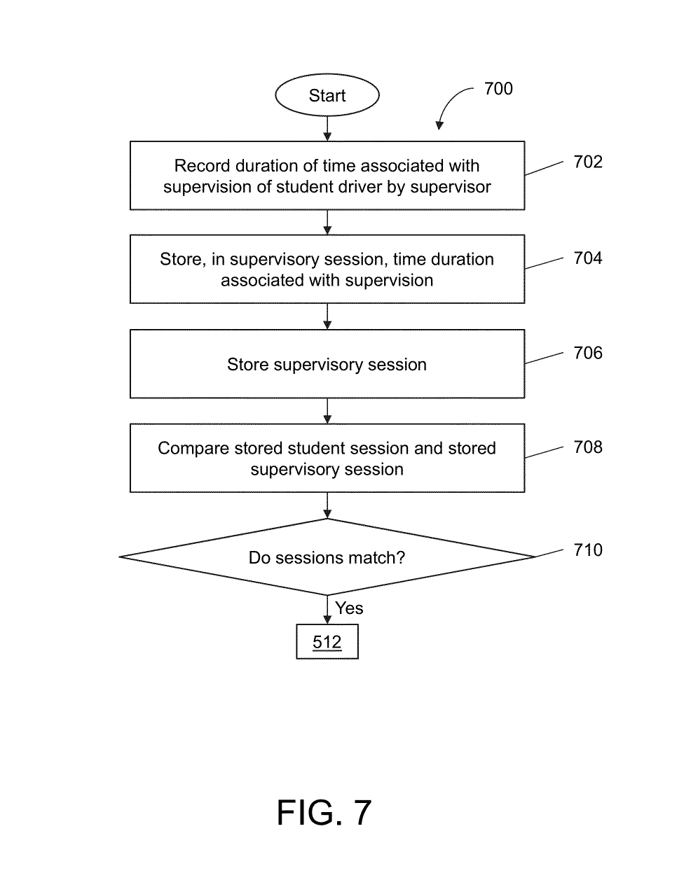

At an operation 510, a determination of whether a first supervisor was present with the student driver during the driving may be effectuated. As indicated, such a determination may be effectuated via a number of approaches. For example, in various implementations, the first supervisor may be prompted to enter an input to indicate his/her presence with the student driver (e.g., prompted prior to the driving, during the driving, after the driving, etc.). In some implementations, a second supervisor may be prompted to enter an input to indicate the first supervisor's presence with the student driver during the driving (e.g., prompted prior to the driving, during the driving, after the driving, etc.). As an example, the first supervisor may include a parent, a legal guardian, and/or any other authorized supervisor who is present with the student driver during the driving. The second supervisor may include a parent, a legal guardian, and/or any other authorized supervisor who may not necessarily be present with the student driver during the driving, but can attest that the driving of the student driver was directly supervised by the first supervisor in the first supervisor's presence. In certain implementations, a determination of whether the first supervisor is within a predetermined proximity threshold from the student driver during the driving may be effectuated to determine whether the first supervisor was present with the student driver during the driving. In other implementations, such a determination may be effectuated based on methods 600 and 700 of FIGS. 6 and 7, respectively. Operation 510 may be performed by a supervisor confirmation module that is the same as or similar to supervisor confirmation module 210, in accordance with one or more implementations. Responsive to a determination that the first supervisor was present with the student driver during the driving, method 500 may proceed to an operation 512.

At operation 512, the pre-licensing requirements of the motor vehicle agency may be obtained. For example, the pre-licensing requirements may be obtained from the client computing platform 102 (e.g., installation of a mobile application for the pre-licensing process may come with pre-loaded pre-licensing requirements), one or more servers of a network service, one or more databases of the motor vehicle agency, etc. The pre-licensing requirements may require that the student driver drive a certain total number of hours, that the certain total number of hours be driven within a particular number of student-driving sessions, that the student-driving sessions include a certain number of day driving and a certain number of night driving, that all of the recorded time for the student-driving sessions be supervised and confirmed by an authorized supervisor, and/or that the student driver perform other necessary tasks. Operation 512 may be performed by a compliance determination module that is the same as or similar to compliance determination module 212, in accordance with one or more implementations.

At an operation 514, the pre-licensing requirements and the stored student-driving session may be compared to generate status information of the student driver with respect to fulfillment of the pre-licensing requirements. As indicated, in some implementations, the pre-licensing requirements and a combination of stored student-driving sessions associated with the student driver may be compared to generate status information indicating the pre-licensing requirements that the student driver has fulfilled and the pre-licensing requirements that the student driver still needs to satisfy. Operation 514 may be performed by a compliance determination module that is the same as or similar to compliance determination module 212, in accordance with one or more implementations.

At an operation 516, a determination of whether the student driver has fulfilled the pre-licensing requirements may be effectuated. For example, the generated status information may indicate the pre-licensing requirements that the student driver has fulfilled and the pre-licensing requirements that the student driver still needs to satisfy. Thus, in some implementations, such a determination may be based on the status information. Operation 516 may be performed by a compliance determination module that is the same as or similar to compliance determination module 212, in accordance with one or more implementations. Responsive to a determination that the student driver has fulfilled the pre-licensing requirements, method 500 may proceed to an operation 518.

At operation 518, the status information may be provided to the motor vehicle agency. By way of example, the status information provided to the motor vehicle agency may include information indicating that the student driver has fulfilled all the pre-licensing requirements, session information generated from the various student-driving sessions of the student driver, and/or other information that may be necessary for the motor vehicle agency to pre-qualify the student driver to schedule a licensing test with the motor vehicle agency. Operation 518 may be performed by a notification module that is the same as or similar to notification module 214, in accordance with one or more implementations.

FIG. 6 illustrates a method for confirming supervision presence with the student driver for the student-driving session, in accordance with one or more implementations. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting.

In some embodiments, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

At an operation 602, a supervisory session associated with supervision of the student driver by the first supervisor may be obtained. By way of example, the stored student-driving session may be created and stored at the student driver's mobile device, while the supervisory session may be created and stored at the first supervisor's mobile device. As such, in one implementation, the supervisory session may be obtained from the first supervisor's mobile device. Operation 602 may be performed by a supervisor confirmation module that is the same as or similar to supervisor confirmation module 210, in accordance with one or more implementations.

At an operation 604, the stored student-driving session and the supervisory session may be compared. For example, if the obtained supervisory session and the stored student-driving session indicate substantially the same distance traveled, the same route traveled, the same time duration, the same time/date of the driving, and/or other information that match, it may be determined that the obtained supervisory session and the stored student-driving session match and that the first supervisor was present with the student-driver for the student-driving session. Operation 604 may be performed by a supervisor confirmation module that is the same as or similar to supervisor confirmation module 210, in accordance with one or more implementations.

At an operation 606, a determination of whether the stored student-driving session and the supervisory session match may be effectuated. Operation 606 may be performed by a supervisor confirmation module that is the same as or similar to supervisor confirmation module 210, in accordance with one or more implementations. Responsive to a determination that the stored student-driving session and the supervisory session match, method 600 may proceed to operation 512 of FIG. 5.

FIG. 7 illustrates another method for facilitating fulfillment and verification of one or more pre-licensing requirements of a motor vehicle agency for a student driver, in accordance with one or more implementations. The operations of method 700 presented below are intended to be illustrative. In some embodiments, method 700 may be accomplished with one or more additional operations not described, and/or without one or more of the operations discussed. Additionally, the order in which the operations of method 700 are illustrated in FIG. 7 and described below is not intended to be limiting.

In some embodiments, method 700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 700 in response to instructions stored electronically on an electronic storage medium. The one or more processing devices may include one or more devices configured through hardware, firmware, and/or software to be specifically designed for execution of one or more of the operations of method 700.

At an operation 702, a duration of time associated with supervision of the student driver by the first supervisor may be recorded. As indicated, in some implementations, the recording of the time duration associated with the supervision may respectively be started and/or stopped when the first supervisor manually indicates via a mobile application that he/she has started and/or stopped supervising the driving of the student driver (e.g., by entering an identification and/or passcode associated with the first supervisor at the beginning and end of the supervision). Operation 702 may be performed by a recording module that is the same as or similar to recording module 202, in accordance with one or more implementations.

At an operation 704, the time duration associated with the supervision may be stored in a supervisory session. In some implementations, the time duration associated with the supervision may be stored in the supervisory session along with information, such as date/time of supervision, distance traveled during supervision, route traveled during supervision, etc. Operation 704 may be performed by a recording module that is the same as or similar to recording module 202, in accordance with one or more implementations.

At an operation 706, the supervisory session may be stored. For example, the supervisory session may be stored on client computing platform 102, at one or more servers of a network service, etc. Operation 706 may be performed by a session storage module that is the same as or similar to session storage module 208, in accordance with one or more implementations.

At an operation 708, the stored student session and the stored supervisory session may be compared. Operation 708 may be performed by a supervisor confirmation module that is the same as or similar to supervisor confirmation module 210, in accordance with one or more implementations. At an operation 710, a determination of whether the stored student-driving session and the stored supervisory session match may be effectuated. As indicated, as an example, if the stored student-driving session indicates that the student driver drove from time period X2-X9, and the stored supervisory session indicates that the first supervisor supervised the student driver from time period X1-X6, it may be determined that the stored sessions match with respect to the time period from X2-X6. As such, the presence of the first supervisor during the student driver's driving may be confirmed with respect to the time period from X2-X6. Operation 710 may be performed by a supervisor confirmation module that is the same as or similar to supervisor confirmation module 210, in accordance with one or more implementations. Responsive to a determination that the stored student-driving session and the stored supervisory session match, method 700 may proceed to operation 512 of FIG. 5.

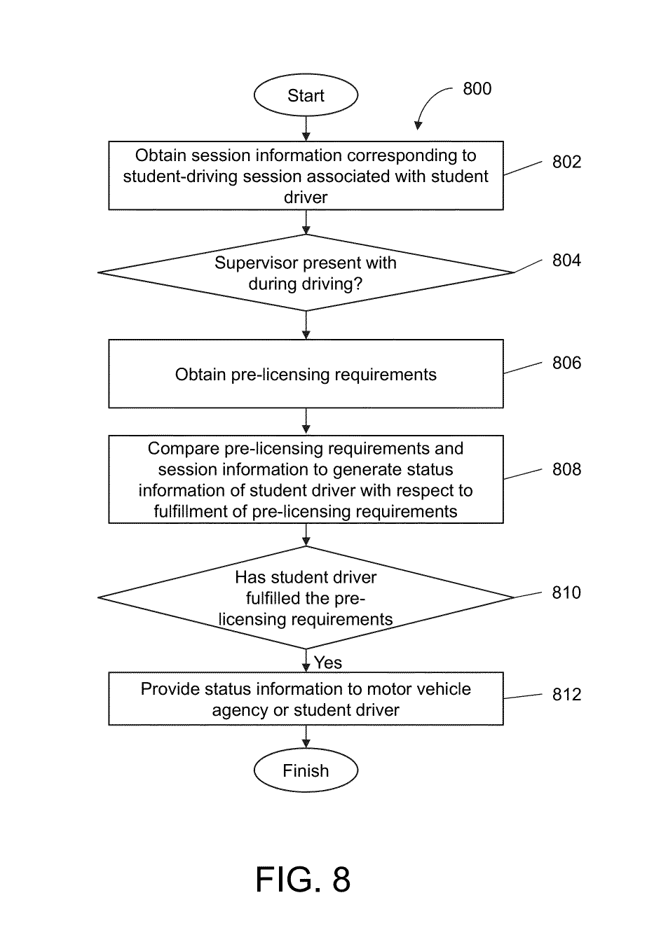

FIG. 8 illustrates another method for facilitating fulfillment of one or more pre-licensing requirements of a motor vehicle agency for a student driver, in accordance with one or more implementations. The operations of method 800 presented below are intended to be illustrative. In some embodiments, method 800 may be accomplished with one or more additional operations not described, and/or without one or more of the operations discussed. Additionally, the order in which the operations of method 800 are illustrated in FIG. 8 and described below is not intended to be limiting.

In some embodiments, method 800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800.

At an operation 802, session information corresponding to a student-driving session associated with the student driver may be obtained. As discussed, in some implementations, the session information may indicate a duration of time associated with driving of the student driver. The time duration associated with the driving may be recorded during the time associated with the driving. Operation 802 may be performed by a compliance determination module that is the same as or similar to compliance determination module 212, in accordance with one or more implementations.

At an operation 804, a determination of whether a first supervisor was present with the student driver during the driving may be effectuated. By way of example, session information may be obtained by a network service (e.g., hosting the licensing platform 104) from the student driver's mobile device. The network service may determine whether the first supervisor was present with the student driver for the student-driving session using one or more of the confirmation techniques described herein. Operation 804 may be performed by a supervisor confirmation module that is the same as or similar to supervisor confirmation module 210, in accordance with one or more implementations. Responsive to a determination that the first supervisor was present with the student driver during the driving, method 800 may proceed to an operation 806.

At operation 806, the pre-licensing requirements of the motor vehicle agency may be obtained. For example, the pre-licensing requirements may be obtained from the client computing platform 102 (e.g., installation of a mobile application for the pre-licensing process may come with pre-loaded pre-licensing requirements), one or more servers of a network service, one or more databases of the motor vehicle agency, etc. The pre-licensing requirements may require that the student driver drive a certain total number of hours, that the certain total number of hours be driven within a particular number of student-driving sessions, that the student-driving sessions include a certain number of day driving and a certain number of night driving, that all of the recorded time for the student-driving sessions be supervised and confirmed by an authorized supervisor, and/or that the student driver perform other necessary tasks. Operation 806 may be performed by a compliance determination module that is the same as or similar to compliance determination module 212, in accordance with one or more implementations.

At an operation 808, the pre-licensing requirements and the session information may be compared to generate status information of the student driver with respect to fulfillment of the pre-licensing requirements. As indicated, the pre-licensing requirements and the session information (along with other session information associated with the student driver) may be compared to generate status information indicating the pre-licensing requirements that the student driver has fulfilled and the pre-licensing requirements that the student driver still needs to satisfy. Operation 808 may be performed by a compliance determination module that is the same as or similar to compliance determination module 212, in accordance with one or more implementations.

At an operation 810, a determination of whether the student driver has fulfilled the pre-licensing requirements may be effectuated. For example, the generated status information may indicate the pre-licensing requirements that the student driver has fulfilled and the pre-licensing requirements that the student driver still needs to satisfy. Thus, in some implementations, such a determination may be based on the status information. Operation 810 may be performed by a compliance determination module that is the same as or similar to compliance determination module 212, in accordance with one or more implementations. Responsive to a determination that the student driver has fulfilled the pre-licensing requirements, method 800 may proceed to an operation 812.

At an operation 812, the status information may be provided to the motor vehicle agency, the student driver, and/or other entities. By way of example, the status information provided to the motor vehicle agency may include information indicating that the student driver has fulfilled all the pre-licensing requirements, session information generated from the various student-driving sessions of the student driver, and/or other information that may be necessary for the motor vehicle agency to pre-qualify the student driver to schedule a licensing test with the motor vehicle agency. Operation 812 may be performed by a notification module that is the same as or similar to notification module 214, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method for facilitating fulfillment and verification of one or more pre-licensing requirements of a motor vehicle agency for a student driver, the method being implemented in a computer system comprising one or more processors configured to execute computer program modules, the method comprising:
recording, by a recording module, a duration of time associated with driving of the student driver, the recording occurring during the time associated with the driving;
storing, by the recording module, the time duration associated with the driving in a student-driving session;
storing, by a session storage, module, the student-driving session; and
confirming, by a supervisor confirmation module, a presence of a first supervisor of the student driver with the student driver during the driving.

2. The method of claim 1, further comprising:
obtaining, by a compliance determination module, the pre-licensing requirements; and
comparing, by the compliance determination module, the pre-licensing requirements and the stored student-driving session to generate status information of the student driver with respect to fulfillment of the pre-licensing requirements.

3. The method of claim 2, further comprising providing, by a notification module, the status information to the motor vehicle agency responsive to a determination that the student driver has fulfilled the pre-licensing requirements.

4. The method of claim 1, wherein the pre-licensing requirements and the stored student-driving session are compared to generate status information of the student driver with respect to fulfillment of the pre-licensing requirements.

5. The method of claim 1, further comprising prompting, by the supervisor confirmation module, the first supervisor to enter an input to indicate the presence, wherein the confirmation is responsive to the input.

6. The method of claim 1, further comprising prompting, by the supervisor confirmation module, a second supervisor to enter an input to indicate the presence, wherein the confirmation is responsive to the input.

7. The method of claim 1, further comprising detecting, by the supervisor confirmation module, a proximity of the first supervisor to the student driver that is within a predetermined threshold during the driving, wherein the confirmation is responsive to the proximity detection.

8. The method of claim 1, further comprising:
obtaining, by the supervisor confirmation module, a supervisory session associated with supervision of the student driver by the first supervisor; and
comparing, by the supervisor confirmation module, the stored student-driving session and the supervisory session to determine whether the stored student-driving session and the supervisory session match, wherein the confirmation is responsive to a determination that the stored student-driving session and the supervisory session match.

9. The method of claim 1, further comprising:
recording, by the recording module, a duration of time associated with supervision of the student driver by the first supervisor;
storing, by the recording module, the time duration associated with the supervision in a supervisory session;
storing, by the session storage module, the supervisory session; and
comparing, by the supervisor confirmation module, the stored student-driving session and the stored supervisory session to determine whether the stored student-driving session and the stored supervisory session match, wherein the confirmation is responsive to a determination that the stored student-driving session and the stored supervisory session match.

10. The method of claim 1, further comprising:
disabling, by a safety module, external communications that are unrelated to the student-driving session responsive to a determination that the driving has begun; and
enabling, by the safety module, the external communications responsive to a determination that the driving has ended.

11. The method of claim 1, further comprising detecting, by a driving detection module, the driving of the student driver, wherein the driving detection is responsive to one or more of detected velocity or detected acceleration of the driving, and wherein the recording is responsive to the driving detection.

12. A system for facilitating fulfillment and verification of one or more pre-licensing requirements of a motor vehicle agency for a student driver, the system comprising:
one or more processors configured to execute computer program modules, the computer program modules comprising:
a recording module configured to record a duration of time associated with driving of the student driver, the recording occurring during the time associated with the driving, and to store the time duration associated with the driving in a student-driving session;
a session storage module configured to store the student-driving session; and
a supervisor confirmation module configured to confirm a presence of a first supervisor of the student driver with the student driver during the driving.

13. The system of claim 12, wherein the computer program modules further comprise a compliance determination module configured to obtain the pre-licensing requirements, and to compare the pre-licensing requirements and the stored student-driving session to generate status information of the student driver with respect to fulfillment of the pre-licensing requirements.

14. The system of claim 13, wherein the computer program modules further comprise a notification module configured to provide the status information to the motor vehicle agency or the student driver responsive to a determination that the student driver has fulfilled the pre-licensing requirements.

15. The system of claim 12, wherein the pre-licensing requirements and the stored student-driving session are compared to generate status information of the student driver with respect to fulfillment of the pre-licensing requirements.

16. The system of claim 12, wherein the supervisor confirmation module is further configured to prompt the first supervisor to enter an input to indicate the presence, wherein the confirmation is responsive to the input.

17. The system of claim 12, wherein the supervisor confirmation module is further configured to prompt a second supervisor to enter an input to indicate the presence, wherein the confirmation is responsive to the input.

18. The system of claim 12, wherein the supervisor confirmation module is further configured to detect a proximity of the first supervisor to the student driver that is within a predetermined threshold during the driving, wherein the confirmation is responsive to the proximity detection.

19. The system of claim 12, wherein the supervisor confirmation module is further configured to:
obtain a supervisory session associated with supervision of the student driver by the first supervisor; and
compare the stored student-driving session and the supervisory session to determine whether the stored student-driving session and the supervisory session match, wherein the confirmation is responsive to a determination that the stored student-driving session and the supervisory session match.

20. The system of claim 12, wherein the recording module is further configured to record a duration of time associated with supervision of the student driver by the first supervisor, and to store the time duration associated with the supervision in a supervisory session, wherein the session storage module is further configured to store the supervisory session, wherein the supervisor confirmation module is further configured to compare the stored student-driving session and the stored supervisory session to determine whether the stored student-driving session and the stored supervisory session match, and wherein the confirmation is responsive to a determination that the stored student-driving session and the stored supervisory session match.

21. The system of claim 12, wherein the computer program modules further comprise a safety module configured to disable external communications that are unrelated to the student-driving session responsive to a determination that the driving has begun, and to enable the external communications responsive to a determination that the driving has ended.

22. The system of claim 12, wherein the computer program modules further comprise a driving detection module configured to detect the driving of the student driver, wherein the driving detection is responsive to one or more of detected velocity or detected acceleration of the driving, and wherein the recording is responsive to the driving detection.

23. A method for facilitating fulfillment and verification of one or more pre-licensing requirements of a motor vehicle agency for a student driver, the method being implemented in a computer system comprising one or more processors configured to execute computer program modules, the method comprising:
obtaining, by a compliance determination module, session information corresponding to a student-driving session associated with the student driver, wherein the session information indicates a duration of time associated with driving of the student driver, and the time duration associated with the driving was recorded during the time associated with the driving; and
confirming, by a supervisor confirmation module, a presence of a first supervisor of the student driver with the student driver during the driving.

24. The method of claim 23, further comprising:
obtaining, by the compliance determination module, the pre-licensing requirements; and
comparing, by the compliance determination module, the pre-licensing requirements and the session information to generate status information of the student driver with respect to fulfillment of the pre-licensing requirements.

25. The method of claim 24, further comprising providing, by a notification module, the status information to the motor vehicle agency or the student driver responsive to a determination that the student driver has fulfilled the pre-licensing requirements.
